(19) United States
(12) Patent Application Publication
(10) Pub. No.: US 2016/0097140 A1
(43) Pub. Date: Apr. 7, 2016

(54) ENHANCED CONDUCTIVITY METAL-CHALCOGENIDE FILMS VIA POST ELECROPHORETIC DEPOSITION (EPD) TREATMENT

(71) Applicant: CORNELL UNIVERSITY, ITHACA, NY (US)

(72) Inventors: Richard D. Robinson, Ithaca, NY (US); Obafemi Otelaja, Ithaca, NY (US)

(73) Assignee: CORNELL UNIVERSITY, ITHACA, NY (US)

(21) Appl. No.: 14/872,731

(22) Filed: Oct. 1, 2015

Related U.S. Application Data
(60) Provisional application No. 62/058,702, filed on Oct. 2, 2014.

(51) Int. Cl. C25D 13/02; C25D 3/22; C25D 3/30; C01G 3/12; C25D 3/26; C25D 3/34; C25D 3/54; C01B 19/04; C25D 13/12; C25D 3/12

(52) U.S. Cl. CPC C25D 13/02; C25D 13/12; C25D 3/22; C25D 3/30; C25D 3/12; C25D 3/26; C25D 3/34; C25D 3/54; C01B 19/04; C01G 3/12; C01P 2006/40

(57) ABSTRACT

A facile room-temperature method for assembling colloidal copper sulfide (Cu₂₋ₓS) nanoparticles into highly electrically conducting calcogenide material layer films utilizes ammonium sulfide for connecting the nanoparticles, while simultaneously effecting templating surfactant ligand removal. The foregoing process steps transform an as-deposited insulating films into a highly conducting films (i.e., having a conductivity at least about 75 S·cm⁻¹). The methodology is anticipated as applicable to copper chalcogenides other than copper sulfide, as well as metal chalcogenides other than copper chalcogenides. The comparatively high conductivities reported are attributed to better interparticle coupling through the ammonium sulfide treatment. This approach presents a scalable room temperature route for fabricating comparatively highly conducting nanoparticle assemblies for large area electronic and optoelectronic applications.

### CROSS-REFERENCE TO RELATED APPLICATION

This application is related to, and derives priority from, U.S. Provisional Patent Application Ser. No. 62/058,702, titled Non-Stoichiometric Copper Sulfide Nanoparticles, Methods and Applications, and filed 2 Oct. 2014, the contents of which are incorporated herein fully by reference.

### STATEMENT OF GOVERNMENT INTEREST

The research that lead to the embodiments as described herein, and the invention as claimed herein, was funded: (1) in part by the United States National Science Foundation under Agreement No. DMR-1149036; and (2) in part by the Energy Materials Center at Cornell (EMC²), an Energy Frontier Research Center funded by the United States Department of Energy, Office of Science, Office of Basic Energy Science, under Award Number DE-SC0001086. This work also made use of the Cornell Center for Materials Research (CCMR) shared facilities which are supported through the NSF MRSEC program (DMR-1120296). Device fabrication for the embodiments was performed at the Cornell Nanoscale Facility, a member of the National Nanotechnology Infrastructure Network, which is supported by the United States National Science Foundation under Grant ECS-0335765. The United States Government has rights in the invention as claimed herein.

### BACKGROUND

1. Field

The embodiments relate generally to metal chalcogenide materials. More particularly the embodiments relate to metal chalcogenide materials with enhanced performance.

2. Description

A need for alternative cost effective processing methodology for fabricating semiconductor electronics devices and components has spurred interesting research efforts in recent years. To that end, and in addition to a lower cost, evolving semiconductor solution processing methodology and apparatus generally also allow for large area and flexible electronic substrate application fabrication compared with conventional semiconductor processing methods which often employ vacuum processing methodology and apparatus.

Since cost efficient methods for forming semiconductor material films are likely to continue to be of interest within many applications, desirable are additional semiconductor material film processing methods that cost efficiently provide processed semiconductor material layer films with enhanced and desirable properties.

### SUMMARY

The embodiments consider and evaluate an electrophoretic deposition (EPD) method as an alternate deposition method to provide for the fabrication of nanoparticle films that show great promise for electronic applications such as but not limited to semiconductor electronic film applications. With respect to nanoparticle deposition, EPD is accomplished by applying a voltage between two conducting electrodes immersed in a solution containing nanoparticles. The resulting electric field drives the charged nanoparticles through the solution, onto electrodes of opposite polarity. The versatility of EPD for fabricating a wide variety of films of different materials, EPD's efficient use of the colloidal particles (most particles in solution are deposited), and the possibility of depositing films on substrates of arbitrary size and geometry, makes EPD an attractive method for depositing nanoparticle films for various applications. In accordance with the embodiments EPD is shown to result in closely packed nanoparticle assemblies, often with mechanical robustness. While the mechanical stability of EPD films over conventional film deposition is demonstrated, little is known about the electronic properties of the films deposited via EPD.

As a separate consideration, copper sulfide (i.e., Cu(I)S or Cu₂S) is known as a p-type semiconductor material that has generated a great deal of interest due to its potential use in optoelectronic applications. While several methods such as physical deposition methods (evaporation and sputtering), pulsed chemical vapor deposition methods, and chemical bath deposition methods have been used to deposit Cu₂₋ₓS films, a facile method suitable for large scale applications is desirable. Hence, a simple and robust method for solution-based processing of conducting Cu₂₋ₓS films is important, at least in theory.

Within the context of the foregoing discussion which centers around an EPD nanoparticle deposition method and Cu₂₋ₓS films, the embodiments utilize EPD as an alternate method for depositing conducting Cu₂₋ₓS nanoparticle films. The embodiments study the affect of deposition methods on electronic transport properties of EPD and spin-cast Cu₂₋ₓS films. In accordance with the embodiments a room-temperature method for realizing comparatively highly conductive Cu₂₋ₓS nanoparticle films involves a chemical post-treatment of an as-deposited Cu₂₋ₓS nanoparticle film with ammonium sulfide—a process that replaces bulky surfactant ligands intrinsic to the as-deposited Cu₂₋ₓS nanoparticle film with metal-sulfide bonds—transforming the as-deposited Cu₂₋ₓS nanoparticle insulating films into a comparatively highly conducting Cu₂₋ₓS nanoparticle film. When one compares the electronic properties of copper sulfide nanoparticle-based films deposited via electrophoretic deposition and spin-casting, one may find that spin-casting can yield Cu₂₋ₓS nanoparticle films with high conductivities (5.7 S·cm⁻¹) and mobilities (4.3 cm²V⁻¹ s⁻¹), and that the EPD Cu₂₋ₓS nanoparticle films consistently have an order of magnitude higher conductivity (up to 75 S·cm⁻¹ (or at least about 75 S·cm⁻¹)) in comparison with the spin-cast films. It is believed that this observation could pave the way for new methods of room temperature processing of nanoparticles for applications such as but not limited to printable electronics.

While this disclosure primarily illustrates and describes the embodiments within the context of the copper sulfide films of chemical composition Cu₂₋ₓS as derived from EPD of nanoparticles, this disclosure is not intended to be so limited. Rather the embodiments also contemplate improved performance of copper chalcogenide films other than copper sulfide films (i.e., including but not limited to copper selenide films and copper telluride films). As well, the embodiments also contemplate enhanced performance of metal chalcogenide films other than copper chalcogenide films. These metal chalcogenide films other than copper chalcogenide films may be selected from the group including but not limited to manganese sulfide films, molybdenum disulfide films, lead sulfide films, cadmium sulfide films and cadmium selenide films.

A structure in accordance with the embodiments includes a substrate and a copper chalcogenide material layer located over the substrate and having a conductivity at least about 50 S·cm⁻¹.

Another structure in accordance with the embodiments includes a substrate and a copper sulfide material layer located over the substrate and having a conductivity at least about 75 S·cm⁻¹.

A method in accordance with the embodiments includes depositing while using an electrophoretic deposition method a metal nanoparticle material layer upon a substrate. The method also includes treating the metal nanoparticle material layer with a chalcogenide source material to form from the metal nanoparticle material layer upon the substrate a metal chalcogenide material layer upon the substrate.

Another method in accordance with the embodiments includes forming upon a substrate while using an electrophoretic deposition method a surfactant templated copper nanoparticle material layer. The method also includes treating the surfactant templated copper nanoparticle material layer with a sulfur material to form from the surfactant template copper nanoparticle material layer a copper sulfide material layer having a conductivity at least about 75 S·cm⁻¹.

### BRIEF DESCRIPTION OF THE DRAWINGS

The objects, features and advantages of the embodiments are understood within the context of the Detailed Description of the Non-Limiting embodiments, as set forth below. The Detailed Description of the Non-Limiting Embodiments is understood within the context of the accompanying drawings, which form a material part of this disclosure, wherein:

FIG. 1 shows: a) A schematic depiction of experimental plan to study electronic transport in EPD and spin-cast copper sulfide films. b) A TEM of starting copper sulfide nanoparticles with average particle size of 5 nm. c) An AFM height image showing a step in height between the film and regions from which the films have been cleaned off, revealing film thickness.

FIG. 2 shows: a) An XRD pattern of the copper sulfide film before and after ammonium sulfide treatment compared to the Djurleite Cu_{1.94}S (JCPD 23-0959), Roxbyite Cu_{1.81}S (JCPDS 23-0958), and low-chalcocite Cu₂S (JCPDS 33-0490) phases of copper sulfide. A close match to the Djurleite is observed, indicating the presence of copper vacancies. b) A TEM of Cu₂₋ₓS nanoparticles scraped off from EPD films without ammonium sulfide treatment. The films are insulating without ammonium sulfide treatment. c) A TEM of Cu₂₋ₓS nanoparticles scraped off from EPD films treated with ammonium sulfide. These films have conductivities as high as 75 Scm¹ at room temperature. The particles are scraped off from films made by three EPD cycles.

FIG. 3 shows high resolution XPS scan of the Cu 2p region for Spin-cast and EPD films (a) Spin cast film before ammonium sulfide treatment. (b) Spin cast film after ammonium sulfide treatment. (c) EPD film before ammonium sulfide treatment. (d) EPD film after ammonium sulfide treatment. The Cu 2p_{3/2} peak in (a) and (c) indicates a shift to higher binding energy, a consequence of oxidation. Satellite peaks (Cu²⁺) at ˜943 eV observed in (a) and (c) are not observed in (b) and (d). See FIG. 17 for corresponding high resolution scans for the S 2p region.

FIG. 4 shows Hall Effect measurements for two spin-cast films on glass substrates. Films are treated with ammonium sulfide. The Hall voltage is determined for varying magnetic field (−4 to 4 Tesla). Polarity of the Hall voltage indicates the Cu₂₋ₓS are p-type semiconducting.

FIG. 5 shows temperature-dependent electrical conductivity measurements. a) Conductivity measurements of EPD and spin-cast films from 25 to 300 K showing a decrease in conductivity with decreasing temperature. EPD films show an order of magnitude enhancement in conductivity. b) Semi-log plot of conductivity (ln σ vs. (1/T)^{1//4} shows variable-range hopping (VRH) conduction. The black solid lines are fits of the conductivity using Mott-VRH with ¼ power temperature dependence. The data is best fit to a Mott-VRH (See Table 6).

FIG. 6 shows FET measurements of EPD and spin-cast films. a) Log-log plot of drain-source current as function of drain-source voltage (FET output characteristics). The plot shows minimal gate modulation and no saturation for both films. Channel width and length is 1 mm and 2.5 μm. Slight increase in drain current with negative gate voltages suggests a p-type channel. b) Semi-log plots of drain-source current as a function of gate voltage (FET transfer characteristics) at a constant V_{DS} of 5 V. EPD films conduct higher drain currents than spin-cast films. FET mobilities extracted from plots in b) are 1.12 cm²V⁻¹s⁻¹ and 0.0087 cm²V⁻¹s⁻¹ for EPD and spin-cast films respectively.

FIG. 7 shows Capacitance-Voltage studies. a) Schematic of the of Metal (Au)-Semiconductor (copper sulfide)-Insulator (silicon oxide)-Metal (doped-Si) (MSIM) capacitors fabricated with EPD and spin-cast films. Also shown is the equivalent capacitance of the MSIM structure, which is a series connection of oxide (C_{OX}) and nanoparticle film capacitance (C_{NP}). b) High-frequency (100 KHz) Capacitance-Voltage (C-V) measurements of the MSIM capacitor in a). Estimated oxide capacitance assumes a dielectric constant of 3.9 and thickness of ˜300 nm. Area is ˜4.8 mm².

FIG. 8 shows SEM and AFM images of EPD (left hand side (blue in color) outlines) and spin-cast (right hand side (red in color) outlines) films treated with ammonium sulfide. a-d) Low and high magnification SEM micrographs of typical EPD (a, b) and spin-cast (c, d) films after ammonium sulfide treatment. EPD is shown to form more tightly packed films than spin-cast films. e) AFM height image of typical EPD film. f) AFM height image of typical spin-cast film. g) AFM phase image of typical EPD film. h) AFM phase image of typical spin-cast film.

FIG. 9 shows SEM of EPD films with and without ammonium sulfide treatment. Magnification increases from left to right. Without the ammonium sulfide treatment that links the particle together, the EPD films are insulating.

FIG. 10 shows four-wire resistance measurement of EPD pre-ammonium sulfide treatment. Measurement instrument (Keithley 237) reaches compliance voltage of 0.2 V at 1 nA of source current. This implies that the sheet resistance will be in the order of GΩ; hence, one may conclude the films are insulating before ammonium sulfide treatment.

FIG. 11 show image-processed images of SEM micrographs of EPD and spin-cast films (FIGS. 8b and 8d). Images are processed following standard procedures. EPD film has large percentage area of nanoparticles (63%) than spin-cast films (40%) suggesting better film better compaction, which likely enhances interparticle coupling. Since films involve several deposition layers, this type of image analysis is biased to analyze mostly the top layer of the film.

FIG. 12 shows low and high magnification TEM images of nanoparticles scrapped off from spin-cast films treated with ammonium sulfide. Nanoparticles do not appear to be sintered, but are tightly connected.

FIG. 13 shows XPS survey scan of spin-cast film. a) Pre-ammonium sulfide treatment. b) Post-ammonium sulfide treatment.

FIG. 14 shows XPS survey scan of EPD film. a) Pre-ammonium sulfide treatment. b) Post-ammonium sulfide treatment.

FIG. 15 shows high resolution XPS scan of the C is region for spin-cast before (top (red in color)) and after (bottom (magenta in color)) ammonium sulfide treatment.

FIG. 16 shows high resolution XPS scan of the C is region for EPD film before (top (blue in color)) and after (bottom (magenta in color)) ammonium sulfide treatment.

FIG. 17 shows high resolution XPS scan of the S 2p region for spin cast films. (a) Spin-cast film before ammonium sulfide treatment. (b) Spin-cast film after ammonium sulfide treatment. (c) EPD films before ammonium sulfide treatment. (d) EPD films after ammonium sulfide treatment.

FIG. 18 shows plot of temperature-dependent conductivity normalized by the solid fraction of copper sulfide to express the interlinking nanoparticle conductivities of EPD and spin-cast films. EPD and spin-cast films have ˜38% and 57% porosity, respectively. By rescaling the conductivity plot in FIG. 5a, one may show that the lower porosity in EPD films alone does not account for the increase in conductivity.

FIG. 19 shows plot of temperature-dependent resistivity of EPD and spin-cast films that have been thermally cycled from 300 K to 25 K, and then from 25 K to 400 K. 400 K is the maximum temperature obtainable in the measurement apparatus (PPMS). The EPD (blue) and spin-cast (red) vertical arrows indicate the onset of a sharp drop in resistivity for EPD and spin-cast films, respectively. This irreversible increase in conductivity is possibly due to sintering of the nanoparticles in the films or thermal doping. The films measured in this plot have poorer performance than samples from the main text due to aging.

FIG. 20 shows plots of conductivity of a spin-cast film over time. After 50 days in ambient condition, the spin-cast film has about the same order of magnitude room-temperature conductivity, but drops about ½ in value. Film conductivity degrades over time when left in ambient conditions.

FIG. 21 shows Current-Voltage (I-V) measurements of EPD films in the dark (lines) and under illumination (squares) with a 150 W illuminator showing negligible light sensitivity. 4-wire resistance measurements were performed with films deposited on Au electrodes with varying spacing (50 to 400 μm).

FIG. 22 shows Current-Voltage (I-V) measurements of spin-cast films in the dark (lines) and under illumination (squares) with a 150 W illuminator showing negligible light sensitivity. 4-wire resistance measurements were performed with films deposited on Au electrodes with varying spacing (50 to 400 μm).

FIG. 23 shows linear scale plot of drain-source current as a function of drain source voltage (FET output characteristics). Minimal gate modulation is observed. The higher conductivity of the EPD films suppresses the features of the spin-cast film plot when shown in a linear scale. Hence, a log-log plot is shown in FIG. 6a.

FIG. 24 shows a TEM of the starting copper sulfide nanoparticles.

### DETAILED DESCRIPTION OF THE NON-LIMITING EMBODIMENTS

### I. Specific Experimental Embodiments

The experimental embodiments as described below illustrate process steps within a method for forming a non-stoichiometric copper deficient copper sulfide material layer of composition Cu₂₋ₓS with enhanced conductivity.

To that end, one first prepares in non-aqueous solution a comparatively loosely coordinated surfactant templated copper sulfide nanoparticle material composition, where the surfactant comprises a templating surfactant, such as but not limited to oleylamine (i.e., other long chain C-10 to C-18 alkyl or related amines are also anticipated). A dispersion of such a comparatively loosely coordinated surfactant templated copper sulfide nanoparticle material is then prepared and used as a source material for EPD of the comparatively loosely coordinated surfactant templated copper sulfide nanoparticle material upon a substrate which is typically although not necessarily a conducting substrate or a semiconducting substrate. At this point in processing of the comparatively loosely coordinated surfactant templated copper sulfide material layer has a chemical composition of about Cu_{1.194-1.196}S and has a conductivity less than about 1e-5 S·cm⁻¹ (and typically from about 0.1e-5 to about 0.5e-5 S·cm⁻¹), while also having a thickness from about 100 to about 150 nanometers. Such a thickness will often depend upon a number of EPD process steps with 3 EPD process steps generally providing the thickness from about 100 to about 150 nanometers. Thicknesses of up to about one micron are anticipated in accordance with the embodiments. Within the context of the embodiments and also the claims, such a comparatively loosely coordinated surfactant templated copper sulfide nanoparticle material layer may be regarded as essentially a comparatively “bare” copper sulfide nanoparticle material layer.

Next, the substrate including the comparatively loosely coordinated surfactant templated copper sulfide material layer with the chemical composition of about Cu_{1.194-1.196}S and conductivity from about 0.1e-5 to about 0.5e-5 S·cm⁻¹ is further treated with additional ammonium sulfide which displaces the comparatively loosely coordinated templating surfactant (i.e., generally oleylamine) and deposits additional sulfur in the form of sulfide to provide a further copper deficient copper sulfide material layer having a net chemical composition Cu_{1.0-2.0}S (i.e., which is expected to result from remaining templating ligand removal and replacement with additional sulfide material, and which is not intended to be indicative of any fundamental crystal structure change with respect to a copper sulfide material) and an electrical conductivity at least about 75 S cm⁻¹ This particularly high electrical conductivity is realized using room temperature processing in accordance with the experimental embodiments as described further below. More generally in accordance with the embodiments, the embodiments for a metal chalcogenide material layer having a thickness from about 100 to about 150 nanometers has: (1) an electrical conductivity at least about 50 S·cm⁻¹; (2) an electrical conductivity at least about 60 S·cm⁻¹; (3) an electrical conductivity at least about 70 S·cm⁻¹; (4) an electrical conductivity at least about 80 S·cm⁻¹; (5) an electrical conductivity at least about 90 S·cm⁻¹; and (6) an electrical conductivity at least about 100 S·cm⁻¹. At a copper:sulfur atomic ratio closer to unity higher electrical conductivities may predominate. This final copper sulfide (or metal chalcogenide) material layer may be regarded as a “composite” copper sulfide nanoparticle material layer, where the original copper sulfide nanoparticles are by virtue of XRD spectra described below presumed to be largely intact but ligand stripped, and now these ligand stripped copper sulfide nanoparticles are also covered and embedded with additional interconnecting sulfide material.

### II. General Applicability

Although the more specifically illustrated experimental embodiments as described below specifically illustrate a non-stoichiometric copper deficient copper sulfide material layer with an enhanced conductivity as formed incident to treatment of a surfactant templated copper sulfide material layer with an ammonium sulfide material, the embodiments are not intended to be so limited.

Rather the embodiments consider copper chalcogenide forming materials including but not limited to ammonium sulfide, ammonium selenide and ammonium telluride chalcogenide forming materials, as well as compositionally matched chalcogenidometallates, for copper chalcogenide forming materials when forming a comparatively high conductivity copper chalcogenide material layer in accordance with the embodiments. As well the embodiments generally consider other chalcogenide forming metals for forming a comparatively high conductivity metal chalcogenide material layer in accordance with the embodiments, where such other chalcogenide forming metals include but are not limited to zinc, cobalt, manganese, cadmium, molybdenum and lead chalcogenide forming metals.

As is indicated above, the illustrated experimental embodiments which are directed towards a copper sulfide material layer contemplate a surfactant templated metal chalcogenide treatment time from about 30 to about 90 seconds in order to form a copper sulfide material layer having a thickness from about 100 to about 150 nanometers and a conductivity at least about 75 S·cm⁻¹.

Within the embodiments with respect to copper chalogenide material layers other than copper sulfide material layers, the embodiments contemplate a metal chalcogenide treatment time from about 30 to about 90 seconds to form a copper chalcogenide material layer film other than a copper sulfide material layer film in accordance with the embodiments which will typically have a thickness from about 100 to about 150 nanometers and a conductivity from about at least about 50 S·cm⁻¹ to at least about 100 S·cm⁻¹ and typically from about 60 to about 70 S·cm⁻¹.

Within the embodiments with respect to metal chalcogenide material layers other than copper chalcogenide material layers, the embodiments contemplate a metal chalcogenide treatment time from about 30 to about 90 seconds to form a metal chalcogenide material layer film of thickness about 100 to about 150 nanometers and a conductivity from about 60 to about 100 S·cm⁻¹.

A metal chalcogenide material layer (including a copper sulfide material layer, a copper chalcogenide material layer other than a copper sulfide material layer and a metal chalcogenide material layer other than a copper chalcogenide material layer), may be used within a device selected from the group including but not limited to a FET, a PV cell and an LED.

In addition, as an intrinsic p-type semiconductor, copper sulfide has recently attracted considerable interest as a promising material with potential applications in solar cells, optical filters, nanometer-scale switches, thermoelectric and photoelectric transformers, gas sensors and photocatalysts

### III. Experimental Details for Copper Sulfide Material Layers

### A. Overview of Experimental Procedures

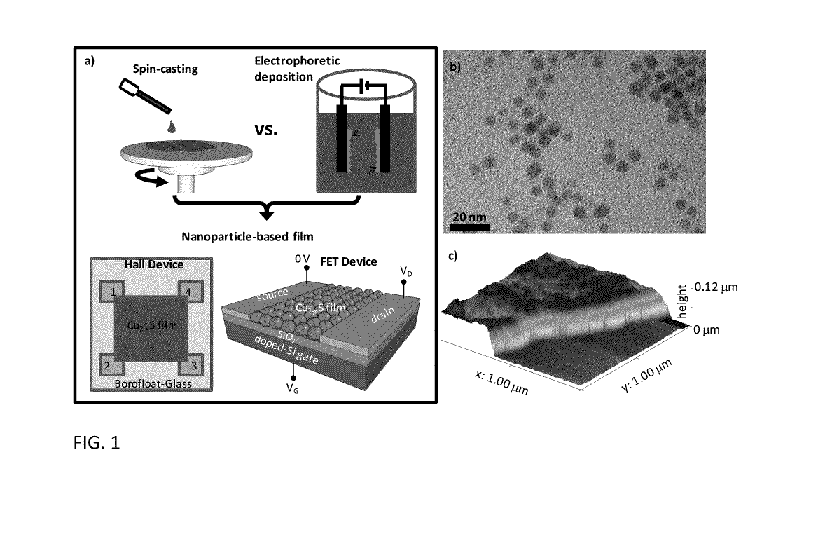

The embodied experimental plan is summarized in the schematic of FIG. 1a, showing colloidal Cu₂₋ₓS nanoparticles utilized as building blocks for the fabrication of nanoparticle films via spin-casting and electrophoretic deposition. The copper sulfide nanoparticles shown in FIG. 1b were synthesized in batch to ensure uniformity between multiple devices. In preparation for film deposition the nanoparticles were re-dispersed in hexanes, cleaned, and filtered through 0.2 um polyvinylidene fluoride (PVDF) membranes. The nanoparticles were then deposited by spin-casting or EPD onto the substrates and the electronic properties of the prepared films were studied by performing resistivity, Hall Effect, and field effect transistor (FET) measurements. Different substrates and substrate preparations were used for the Hall and FET measurements to match the experimental needs of each characterization method. For the resistivity and Hall measurements, Cr/Au (5 nm/90 nm) electrodes were deposited on borofloat glass and doped-Si/SiO₂ substrates via electron beam evaporation such that after nanoparticle deposition, the films could be manually patterned into 5 mm squares with 200 um squares of gold contacts at the edges of the film. The FET devices consisted of doped-Si/SiO₂/Cr/Au (500 μm/300 nm/5 nm/100 nm) stacks to form a bottom-gate and bottom-contact transistor once the nanoparticle film was deposited. The substrates (both FET and Hall) used for spin-casting were cleaned in isopropanol, acetone, and methanol and vapor primed with hexamethyldisilazane (HMDS) prior to nanoparticle film deposition. For the spin-cast films ˜50 μl of 5 mg/ml of Cu₂₋ₓS nanoparticles in hexanes are deposited for 30 seconds at 2000 rpm. This spin-casting condition was selected after characterizing the properties of films (conductivity and film homogeneity) obtained from varying spin parameters, primed and unprimed substrates, and varying solution concentration. The EPD of the copper sulfide films was carried out by applying a voltages (up to ˜600 V) for up to 15 minutes between two conducting electrodes arranged in a parallel plate capacitor configuration and immersed in a colloidal solution of copper sulfide nanoparticle dispersed in hexanes, as shown in FIG. 1a. Particles were attracted to the electrodes via Coulombic interaction. The spacing between the electrodes was ˜3 mm, and with hexane having a dielectric constant of ˜1.9, the effective electric field for film deposition was ˜1050 V/cm. The particles were deposited onto the positive electrode, suggesting that the embodied particles are predominantly negatively charged.

### B. Optimal Copper Sulfide Nanoparticle Film Deposition Conditions

Film deposition conditions were optimized to obtain conducting films (>100 nm thickness) in a reproducible manner. The optimal EPD and spin cast conditions are characterized to ensure that the measured films are of identical thicknesses, as conductivity of the films often exhibit thickness dependent behavior. Ensuring that the film thickness obtained from EPD and spin-casting are identical often required multiple deposition cycles. Three EPD and ten spin-cast deposition cycles were usually carried out to obtain identical thicknesses of ˜120 nm. The film thicknesses are determined using an atomic force microscope (AFM) after cleaning a region of the films with a swab tip soaked in hexanes as shown in FIG. 1c. Each deposition cycle consists of spin-casting/EPD of colloidal nanoparticles onto the substrates/devices, followed by an ammonium sulfide (NH₄)₂S ligand replacement step: after each film layer is made by EPD or spin-casting, the substrate is immersed in a 4 mM of (NH₄)₂S/methanol solution for 30 seconds, rinsed in methanol for 30 seconds, and dried in ambient temperature. The ammonium sulfide ligand replacement strips off the organic ligands and replaces them with sulfide anions, resulting in a metal-sulfur terminated nanoparticle surface. With the removal of the bulky organic group the nanoparticle were also brought together in intimate contact. Both these effects (metal-sulfur surface and inorganic connections between nanoparticles) increases interparticle coupling and enhances charge transport. This step is critical for obtaining conductive films; without the ammonium sulfide treatment the films are insulating (i.e., having a conductivity less than about 1e-3 S cm⁻¹.

### IV. Results and Discussion for Copper Sulfide Nanoparticle Films

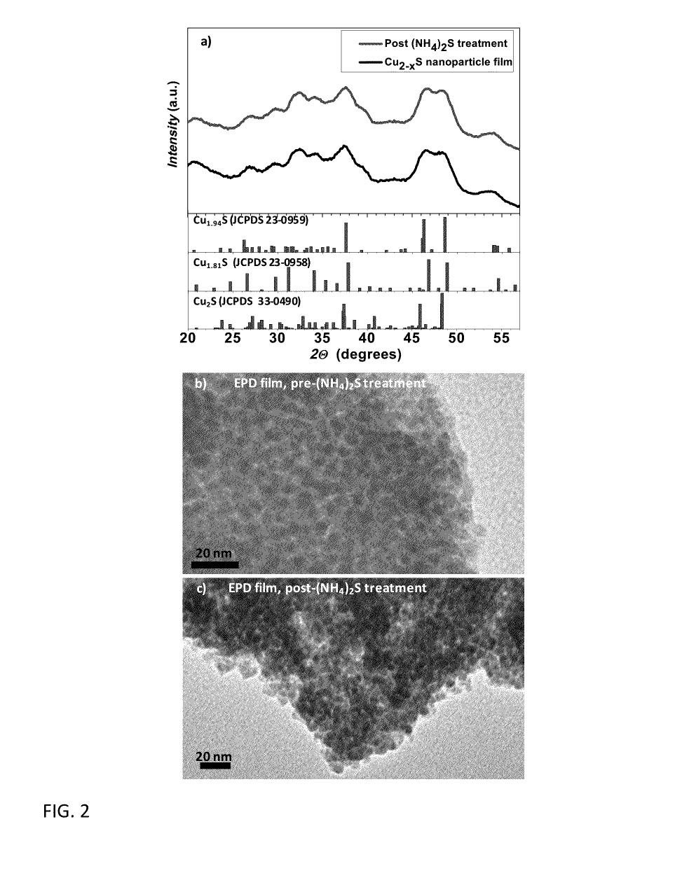

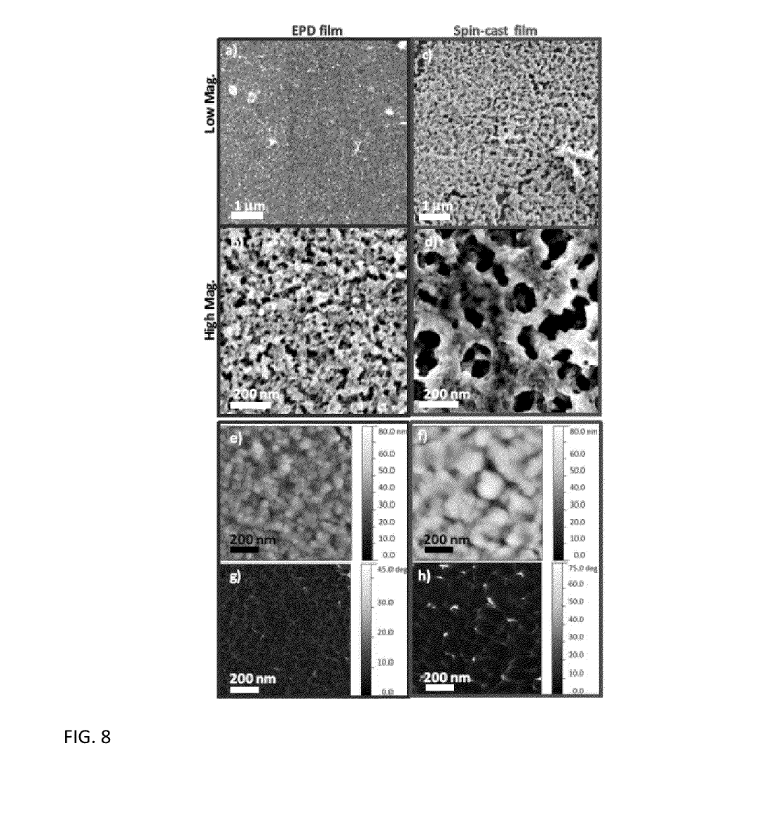

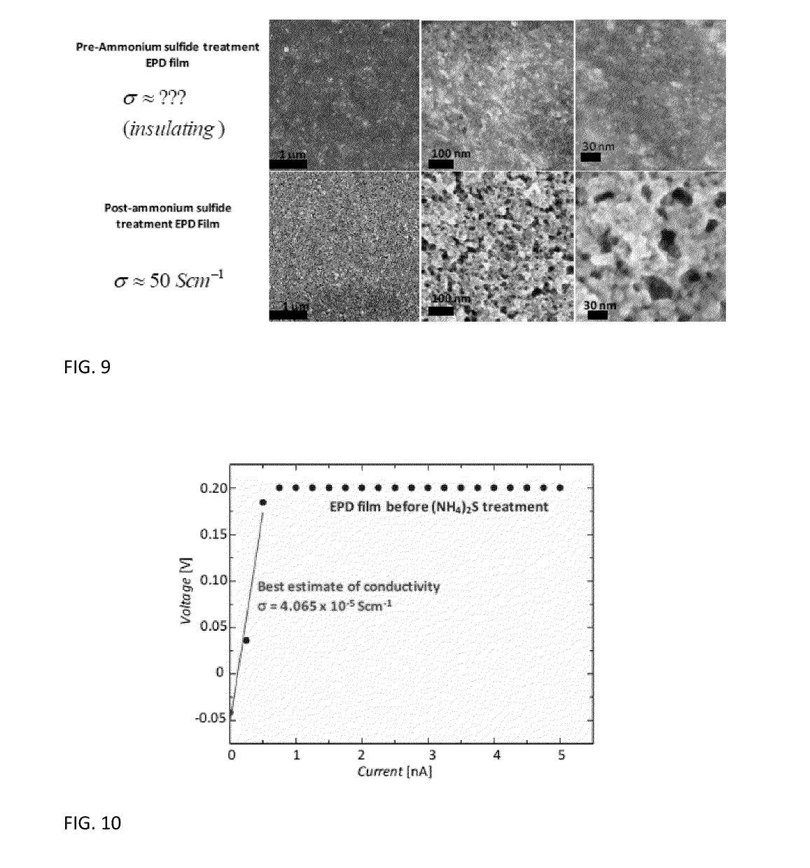

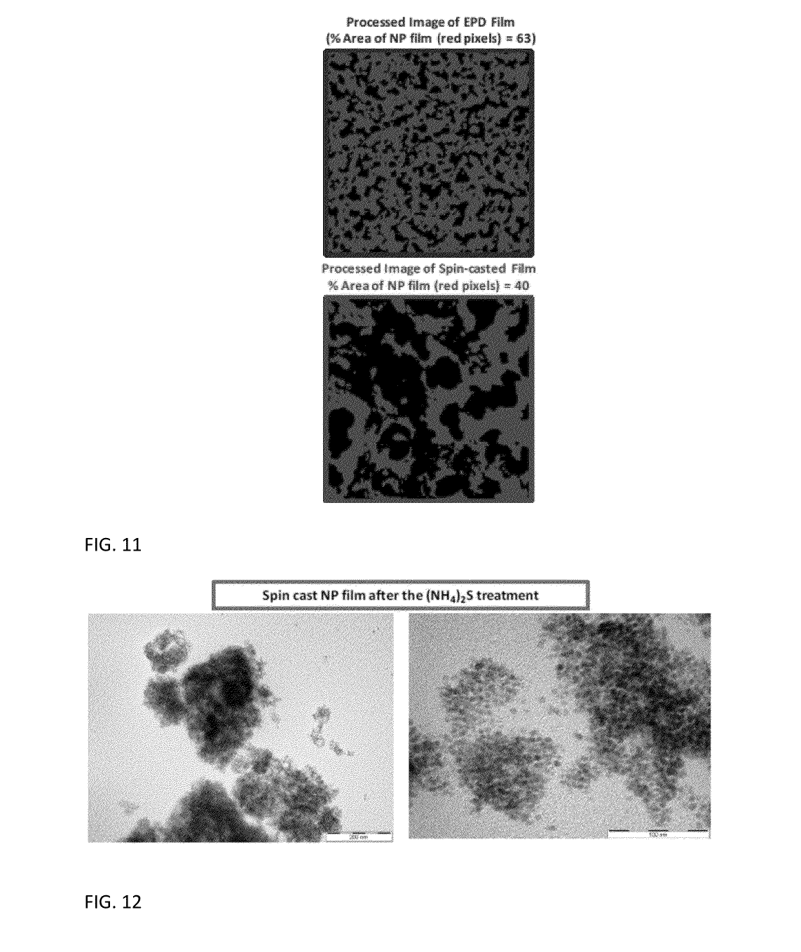

Characterization of the colloidal nanoparticle building blocks by transmission electron microscopy (TEM) and the initial film by X-ray diffraction (XRD) show the nanoparticles having an average size of ˜5 nm and matching the XRD pattern for copper sulfide (FIG. 1b and FIG. 2a). The XRD pattern (FIG. 2a) can be most closely compared to three different phases of copper sulfide Cu₂₋ₓS: low Chalcocite x≈0, Djurleite x=0.06, and Roxbyite x=0.19. Cu₂S has been shown to be an intrinsic semiconductor, whereas the Cu_{1.94}S and Cu_{1.81}S are p-type semiconductors due to the presence of copper vacancies. The XRD pattern of our measured samples match the Djurleite phase most closely; hence, a p-type semiconducting behavior is expected. However, one may note that the exact phase of Cu₂₋ₓS has been known to be difficult to distinguish using XRD patterns alone, as mixed phases and transformation between phases is common. After the ammonium sulfide surface ligand treatment one may observe no changes in the XRD patterns and Scherrer analysis of the XRD peaks indicates a crystal size of ˜4.8 nm both before and after treatment (FIG. 2a), indicating that the particles have not sintered into larger grains and that they have not disintegrated into smaller crystals. The ammonium sulfide treatment used in preparing these films has previously been shown to increase interparticle coupling. TEM images of samples scraped off from the EPD films (FIG. 2b and FIG. 2c) (see FIG. 8 and FIG. 12 for post-ammonium sulfide treatment spin-cast films) suggest that the nanoparticles in the films have not sintered together from the ammonium sulfide treatment, but have formed a closely packed network of nanoparticles inorganically connected. Preliminary analysis of film porosity also suggests that EPD films are better packed than spin-cast films (See FIG. 9, FIG. 11 and FIG. 12). Hence, EPD films should have better interparticle coupling.

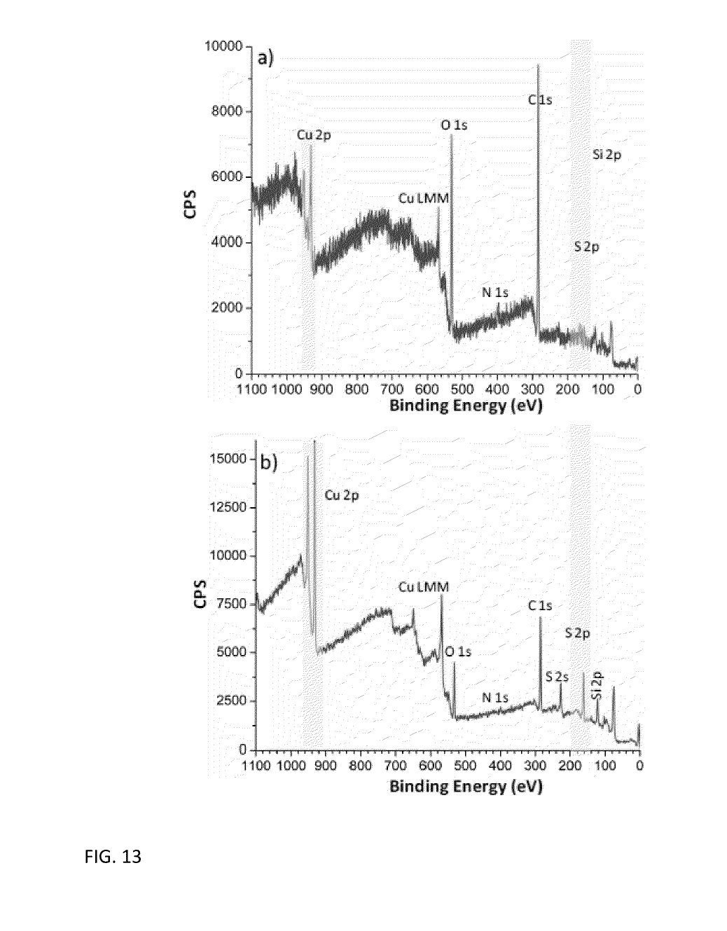

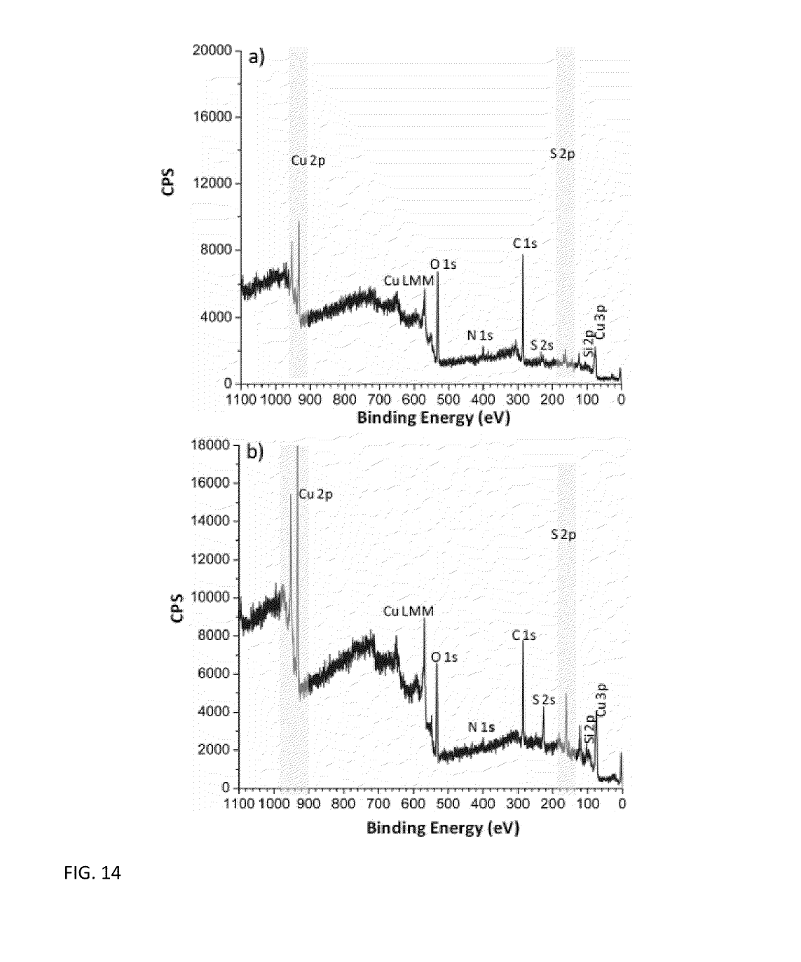

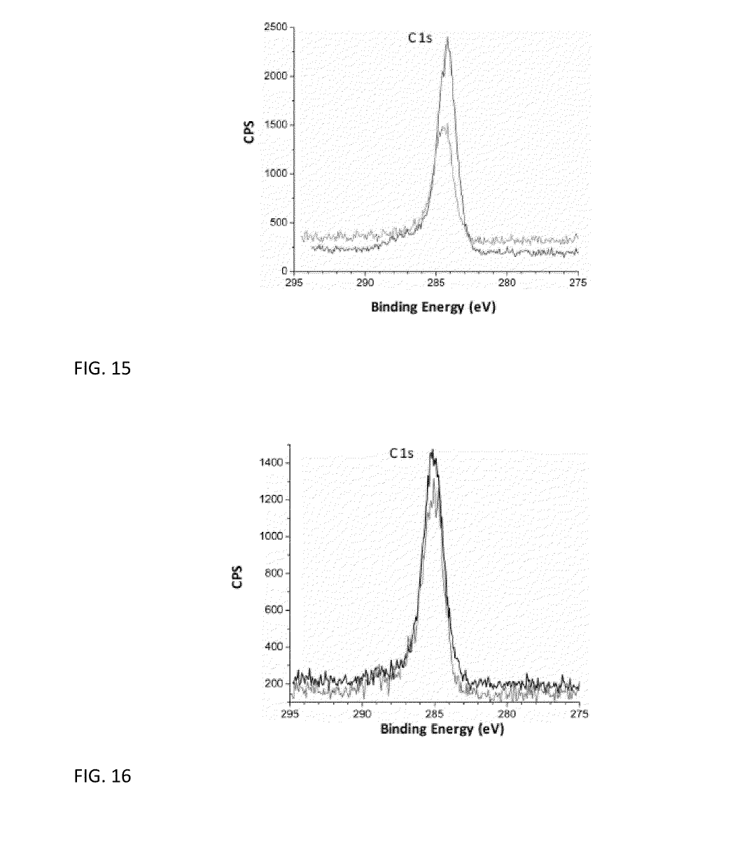

The stoichiometry and composition of the EPD and spin-cast films before and after the ammonium sulfide treatments are characterized with X-ray Photoelectron Spectroscopy (XPS). FIG. 13 and FIG. 14 show XPS survey scans of spin-cast and EPD-films before and after ammonium sulfide treatment. All XPS spectra are calibrated with the binding energy of the C 1 s peak at 284.8 eV and the films were deposited on a doped-Si/SiO₂ substrate. The atomic percentages of the constituent elements are summarized in Table 1. The Cu 2p, S 2p, O 1 s, C 1 s, N 1 s, and Si 2 p peaks are used for calculating the atomic percentages. The ratio of Cu:S before the ammonium sulfide treatment for both spin cast and EPD films is close to 2:1 as expected for Cu₂₋ₓS. However, due to the presence of a significant amount of C, O, and Si, the stoichiometry information obtained for Cu₂₋ₓS from XPS data is not exact. The high resolution XPS spectra of C 1 s in FIG. 15 and FIG. 16 indicate a reduction in carbon content after the ammonium sulfide treatment. After the ammonium sulfide treatment, the ratio of the atomic percentages of Cu:S films is ˜1:1. This increase in sulfur content, in addition to the decrease in C and N peaks, is attributed to the removal of organic ligands and replacement with sulfide anions. The absence of N peaks after treatment also indicates that no inorganic ligands (e.g., (NH₄)₂S or (NH₄)S⁻) or ammonium or ammonia moieties remain after treatment. These results—increase in sulfur, the lack of nitrogen signal, and the decrease in carbon—are all consistent with work and extensive characterization of this ligand removal process.

TABLE I
Atomic Percentage of Elements in Spin-Case and EPD Films Before and
After Ammonium Sulfide Treatment

| | Spin-cast before | Spin-cast after | EPD before | EPD after |
|---|---|---|---|---|
| Element | (NH₄)₂S | (NH₄)₂S | (NH₄)₂S | (NH₄)₂S |
| C | 70.49 | 32.48 | 65.07 | 49.4 |
| O | 21.08 | 17.25 | 24.02 | 14.64 |
| N | 2.15 | 2.87 | 2.1 | 0.45 |
| Cu | 4.12 | 22.03 | 5.96 | 14.72 |
| S | 1.99 | 22.19 | 2.81 | 17.55 |
| Si | 0.16 | 2.78 | 0 | 3.24 |

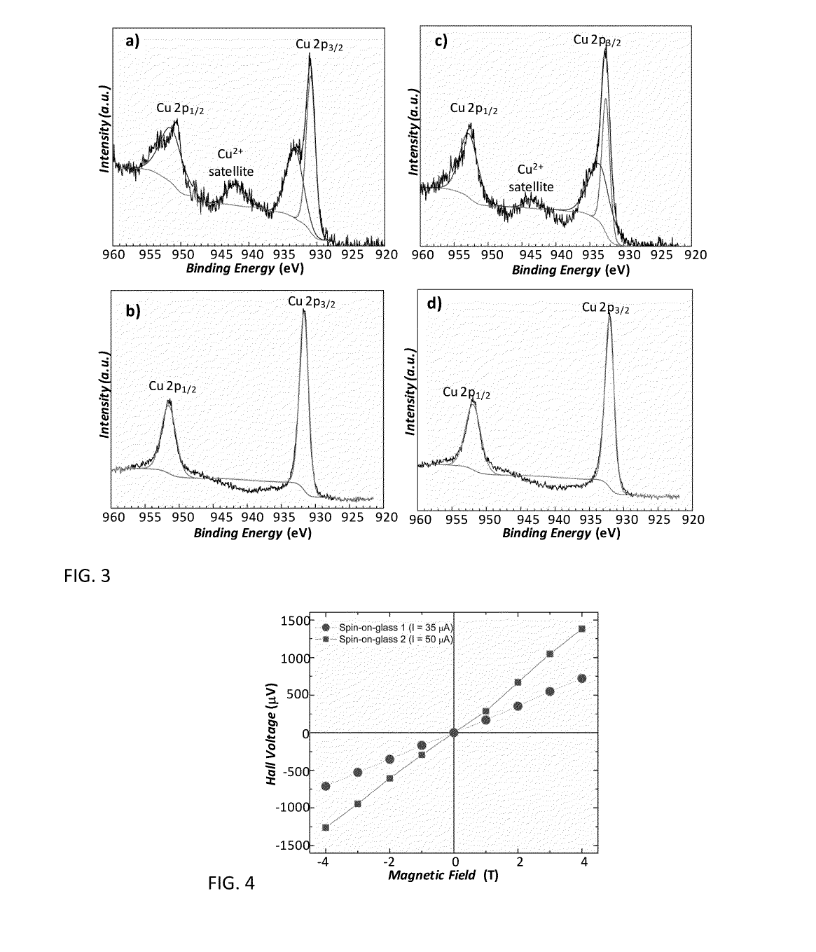

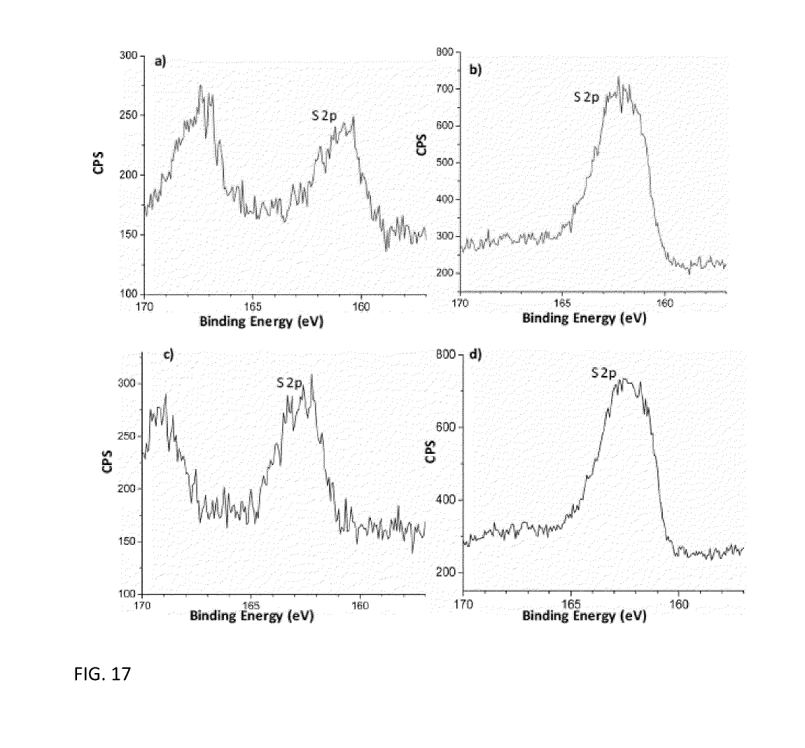

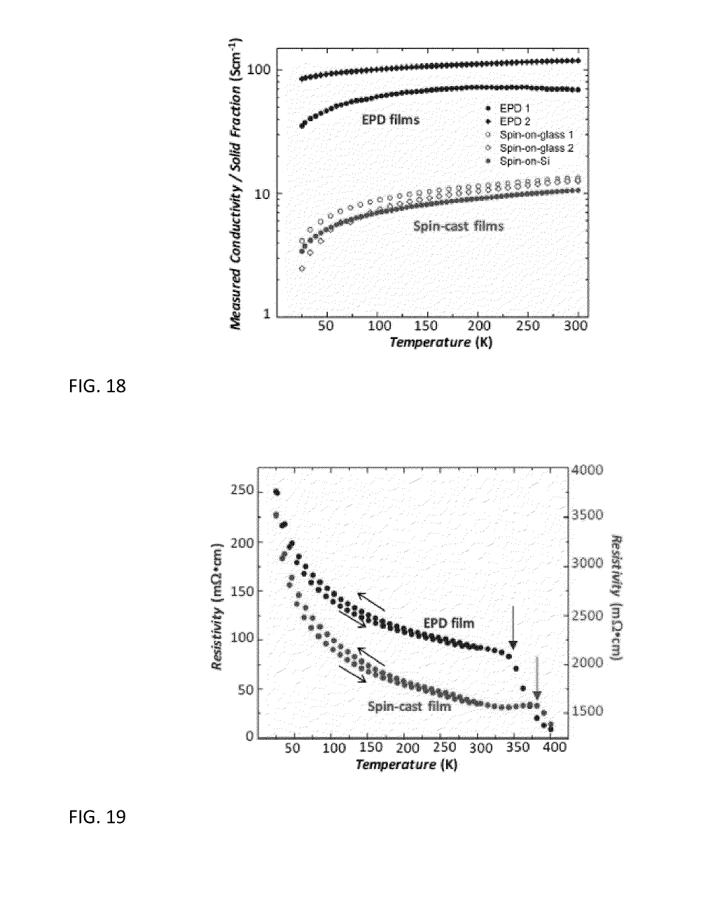

From the high resolution scans of Cu 2p and S 2p in FIG. 3, the chemical states of copper and sulfur in the films were further assessed. The binding energies of Cu 2p_{3/2} and Cu 2p_{1/2} are centered at 932.6 and 952.6 eV respectively, indicating a monovalent state of copper (Cu⁺) as expected in Cu₂S. In addition, the presence of the Cu L₃M_{4,5}M_{4,5} Auger transition with kinetic energy of 918.5 eV (showing up at binding energy ˜568 eV on the survey scans) further suggest a Cu′ state. The satellite peaks which appear at 943.7 eV in the Cu 2p high resolution scans before ammonium sulfide treatment in FIG. 3a and FIG. 3c are due to oxidation. The S 2p spectra in FIG. 17 shows a doublet species with binding energies of 162.7 and 163.9 eV corresponding to S 2p_{3/2} and S 2p_{1/2}. These peaks are indicative of a Cu—S bond formation. While the exact stoichiometry of the Cu₂₋ₓS films is difficult to determine because excess S from the processing can produce misleading values, the XPS and XRD results infer that films in accordance with the embodiments are Cu₂₋ₓS.

Hall effect measurements of the carrier concentration, carrier type, and mobility reveal that the spin-cast copper sulfide films are highly conducting. Colloidal nanoparticles are spin-cast onto the devices for Hall measurements (FIG. 1a) (the substrates for Hall measurements should be non-conducting—in our case, glass—on which EPD cannot be performed). All electrical measurements were done in a Physical Property Measurement System (PPMS Quantum Design). Sheet resistance was measured using the standard van der Pauw approach by determining resistance R₁₄_{_}₂₃, the resistance obtained by applying a DC current (I₁₄) through gold contacts 1 and 4 and measuring the voltage (V₂₃) that develops between gold contacts 2 and 3. By swapping the contact points for current injection and voltage measurements one may observe identical resistance values and conclude that the films are of uniform thickness and suitable for Hall measurements. The sheet resistance is expressed as: Rₛ=πR₁₄_{_}₂₃/ln 2. For Hall Effect measurements one may measure the voltage between contacts 2 and 4, while the current is applied between contact 1 and 3 in the presence of a magnetic field.

TABLE 2
Hall Effect Measurements on Spin-Cast Nanoparticle-Based Films.

| Spin-on- | | Film | | Carrier | Hall |
|---|---|---|---|---|---|
| glass | Slope | thickness | Conductivity | density | mobility |
| films | (V/T) | (nm) | (Scm⁻¹) | (cm⁻³) | (cm² V⁻¹s⁻¹) |
| 1 | 1.79 × 10⁻⁴ | 112 | 5.74 | 1.09 × 10¹⁹ | 3.28 |
| 2 | 3.28 × 10⁻⁴ | 120 | 5.44 | 7.93 × 10¹⁸ | 4.28 |

In FIG. 4, the room temperature magnetic field-dependent Hall voltage V_{H}, measured for two spin-cast films (spin-on-glass 1 and 2) is shown. These samples were prepared identically. The film thicknesses d measured from profilometry and AFM of the two samples 1 and 2 is determined to be 112 nm and 120 nm, respectively. The positive polarity at positive magnetic fields (0 to 4 T) of V_{H} is indicative of a p-type material, which is commonly reported for copper sulfide films with copper vacancies. To ensure measurement accuracy, the polarity of the magnetic field is reversed. After magnetic field reversal, one may observe that the polarity of V_{H} changes, but the magnitude remains approximately the same. This implies an accurate measurement of Hall voltage. One may determine the conductivity (σ=1/Rₛd,) of spin-on-glass samples 1 and 2 to be 5.74 and 5.44 S·cm⁻¹, respectively. One may determine the Hall carrier concentration n_{H} and Hall mobility μ_{H} using the expressions σ=n_{H}·e·μ_{H} and

$${V}_{H} = \frac{IB}{{n}_{H} ed} ,$$

where e is the elementary charge (1.602×10⁻¹⁹ C), I is the applied current, and B is the applied magnetic field. These results are summarized in Table 2. Compared to transistor-based measurements, Hall measurements have the advantage of studying the intrinsic charge transport in nanoparticle-based films independent of charge trapping effects. Hall measurements of the embodiments result in Carrier concentrations of ˜10¹⁹ cm⁻³ and Hall mobilities of ˜3.3 and 4.3 cm²V⁻¹ s⁻¹ for spin-cast Cu₂₋ₓS nanoparticle films 1 and 2, respectively. Because films are insulating before the ligand replacement step, one may attribute these high conductivities to the post-deposition ammonium sulfide treatment, which increases interparticle coupling. Recent results have also shown conductivity enhancements in CuInSe₂ films with virtually bare nanoparticle surfaces after ligand exchange with 1-ethyl-5-thioterazole.

The high conductivities and carrier concentrations of the embodied films are comparable to values previously obtained from low-chalcocite (Cu_{1.999}S and Cu_{1.995}S) copper sulfide films prepared by thermal evaporation (˜1 μm thick) and RF sputtering techniques (0.1-0.5 μm thick): Cu_{1.999}S (7 S·cm⁻¹ and 1.5×10¹⁹ cm⁻³) and Cu_{1.995}S (35 S·cm⁻¹ and 10²⁰ cm⁻³). Even higher conductivities have been reported for anilite phase (Cu_{1.75}S) copper sulfide films, although one may note that: (i) copper sulfides are typically p-type from copper vacancies, with more copper vacancies generally leading to higher conductivity, (ii) XRD from FIG. 2a suggests that the embodied measured films are of the Djurleite phase (Cu_{1.94}S-Cu_{1.96}S), which has fewer copper vacancies than the anilite phase and more copper vacancies than the low-chalcocite phase, (iii) the anilite phase is expected to have higher conductivity than our Djurleite films as there are more copper vacancies in anilite, and (iv) the embodied films are made from nano-size grains without thermal annealing and should not be expected to compete with bulk, however, the embodied results show comparable values to thermally-processed bulk films. Thus, measured values of conductivities for embodied films are remarkably high. When compared to copper sulfide films prepared by pulsed chemical vapor deposition of identical thickness (˜120 nm) and stoichiometry (between Cu_{1.9}S to Cu₂S) the embodied nanoparticle based films show better or identical conductivities. Table 3 summarizes the electrical conductivities of some copper sulfide films previously reported and notes their stoichiometry and method of determination, synthesis and deposition methods, and film thicknesses. Although the results are widely ranging, one may infer that increasing copper vacancies suggest higher conductivities, that annealed films have higher conductivities than un-annealed films, and that the embodied solution processed nanoparticle films perform on par with some of the physically deposited films, even though within the embodied films nanoparticles have not been annealed.

TABLE 3
Comparison of Nanoparticle Based CuₓS Films

| | Deposition | Stoichiometry | Stoichiometry | | | Conductivity | |
|---|---|---|---|---|---|---|---|
| Synthesis | method | (x in CuₓS) | determination | Film thickness | | [Scm⁻³] | Reference |
| Copper target in | RF sputtering/ | 1.995 and 1.959 | Electrochemical | 0.1-0.5 μm/1 μm | | 35 and 7 | Wagner et al.³ |
| Ar—H₂S—H₃ | Evaporation | | methods | | | | |
| atmosphere/ | | | | | | | |
| Cu1.8S source | | | | | | | |
| Copper in H₃S/Ar | RF sputtering | Not specified | None | 1 | μm | 17.6 | Leong et al.⁴ |
| atmosphere | | | | | | | |
| R15 (based on | Pulsed CVD | 1.9-2.0 | EXAFS | 120 | nm | 18.5 | Carbone et al.⁵ |
| Cu(hfac)(tmvs)) | | | | | | | |
| Aqueous Cu | Chemicalty | 1.8 and 2.0 | Rutherford | 120 nm and 50 nm | | 277 and 69 | Grondanov et al.⁶ |
| thiosulfate | deposited | | backscattering | | | | |
| | | | analysis, and film | | | | |
| | | | color | | | | |
| Bath of Coper | Chemicalty | 1.8 | X-ray diffraction | 100 | nm | 2000-10000 (after | Cardoso et al.⁷ |
| chloride, | deposited | | | | | annealing) | |
| triethanolamine, | | | | | | | |
| ammonia, sodium | | | | | | | |
| hydroxide, | | | | | | | |
| thiourea, and Di | | | | | | | |
| water | | | | | | | |
| Bath of Coper | Chemical bath | Not specified | Comparison with | 150-350 | nm | 1-250 (annealed | Nair et al.⁸ |
| chloride, | deposition | | reported | | | and dependent | |
| triethanolamine, | | | stoichiometry- | | | on deposition | |
| ammonia, sodium | | | dependent sheet | | | time) | |
| hydroxide, | | | resistance | | | | |
| thiourea, and Di | | | | | | | |
| water | | | | | | | |
| Dissolution of | Surface induced | 1.75 | Electron | ~100 | nm | ~2000 | Liufu et al.⁸ |
| copper chloride in | nucleation and in- | | diffraction | | | | |
| a mixed solution | situ assembly | | | | | | |
| of water | | | | | | | |
| ammnonium | | | | | | | |
| hydroxide, TEA, | | | | | | | |
| and thiourea | | | | | | | |
| Heat-up colloidal | Spin-casting + | 1.94-1.96 | X-ray Diffraction | ~120 | nm | 5.7/~75 | This work |
| synthesis (Copper | ammonium | | | | | | |
| chloride and | sulfide treatment/ | | | | | | |
| oleylamine)² | EPO + | | | | | | |
| | ammonium | | | | | | |
| | sulfide treatment | | | | | | |

It is interesting to note that a low cost solution-based process is able to realize highly conducting films comparable to bulk deposition methods, without annealing. The embodied films have hole mobilities that are 1 to 4 orders of magnitude higher than hole mobilities previously reported for heat treated nanoparticle films of HgTe, InSb, PbS, PbTe and PbSe. The embodied films also have 1 to 7 orders of magnitude higher conductivity than those of some previously reported metallic nanoparticles of Au, CoPt₃, Ag, Pb, Co, and Pd. Hence, the embodied films are applicable as p-type conducting films, as well as conducting electrodes in an all-nanoparticle based device. However, it is noted that it is difficult to compare different material systems exactly. Such highly conductive nanoparticle-based films made without thermal annealing have also been recently reported for silver nanoparticles. These silver films are metallic in nature while the embodied Cu₂₋ₓS films are p-type semiconducting; hence, the embodied films are more suitable active materials for electronic and optoelectronic applications. In addition, although silver nanoparticle based films could be used for device electrodes, Cu₂₋ₓS films with high conductivities could also be used as electrodes with the added advantage of transparency, although the transparency will be dependent on film thickness.

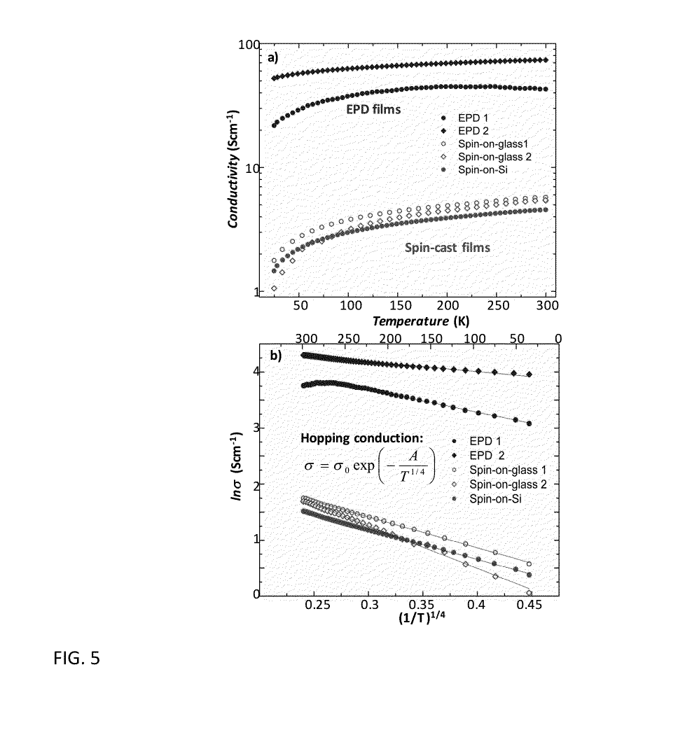

The effect of film deposition methods on the electronic properties of these highly conducting Cu₂₋ₓS were analyzed through temperature-dependent conductivity measurements on films (made via EPD and spin-casting) of identical thicknesses deposited on doped-Si/SiO₂ substrates with Au contact pads. The device geometry is similar to those used for the Hall measurements above, with the exception of a doped-Si/SiO₂ substrate in place of the glass substrate. EPD works for these substrates because the doped silicon is conductive. In addition, measured was the temperature dependence of the conductivity of spin-cast films (spin-on-glass 1 and 2) that were used for Hall Effect measurements. All the electrical measurements are carried out in the PPMS and Ohmic contacts are ensured through wire-bonding. Conductivity is measured following the van der Pauw method described above, and film thicknesses were obtained from profilometry and AFM measurements. FIG. 5a shows the temperature dependent conductivity of Cu₂₋ₓS nanoparticle films formed by EPD (blue closed circles) and spin-casting (red symbols), between 25 K and 300 K. The plots with open red circles and open red diamonds are measurements of films spin-cast onto glass substrates, while the plot with solid red circles is from a film spin-cast onto doped-Si/SiO₂ substrates. Clearly, the effect of the substrate type on conductivity measurements is not discernible. Slight variations in the properties of EPD films between runs are known to result from uncontrolled experimental conditions, such as humidity and temperature.

From the results in FIG. 5a, two points are worth noting: (i) EPD films have an order of magnitude higher conductivity than spin-cast films, and (ii) the conductivity of the films decreases with decreasing temperature. At room temperature, the highest conductivity of all the measured EPD films is 75 S′cm⁻¹, while the highest conductivity from the spin-cast films is 5.7 S·cm⁻¹. This corresponds to resistivities of ˜13.6 me-cm and ˜174 mΩ-cm respectively. One may attribute this order of magnitude enhancement in conductivity seen in EPD films to the close-packing of the nanoparticles as shown in FIG. 8. EPD is suggested to produce closely packed films in an energetically favored assembly, whereas spin-cast films are prone to disorder. These temperature dependent studies further confirm our earlier assertion that EPD films produce better conducting films than spin-cast films. One may infer from such conductivity trends that EPD films will likely have higher carrier mobilities than spin-cast films. One may note that while the ammonium sulfide treatment may introduce some impurities that could potentially dope the films, the EPD and spin-cast films are subjected to identical ammonium sulfide treatment process.

To clarify the conductivity effects, it is necessary to consider the pore volume of the films. The improvement in conductivity of EPD over spin-casting can be a result of higher packing order and/or better interlinking of the nanoparticles in the film. SEM images (FIG. 8 and FIG. 11) indicate that the EPD films are better packed than spin-cast films. To better assess the average porosity one may measure the mass (before and after deposition) and height of the EPD and spin-cast films deposited on a 15 square mm silicon substrate, and calculate the film density. By assuming a bulk density of 5.6 g/cm³ for Cu₂₋ₓS, one may estimate the percentage porosity and the solid fraction of the films (Table 4). EPD films have ˜38% film porosity and 0.62 solid fraction, while spin-cast films have ˜57% film porosity and 0.43 solid fraction, indicating a higher packing fraction for the EPD films. These calculated values are in good agreement with the 2D solid fraction (“% area”) obtained from image-processed SEM images in FIG. 11 (solid fraction of 63% for EPD and 40% for spin-cast). The experimentally measured conductivity (σ_{measured}) should be related to the interlinking conductivity (σ_{IL}) of the nanoparticles and the solid fraction (S_{f}) of the films, by σ_{measured}=σ_{IL}S_{f}. To understand this effect the temperature-dependent conductivity of the films shown in FIG. 5a is rescaled to express conductivity as the interlinking conductivity (σ_{IL}=σ_{measured}/S^{f}), as shown in FIG. 8. Despite normalizing for solid fraction, the EPD films still show an order of magnitude increase in conductivity compared to the spin-cast films. The results of this analysis implies that while the EPD films are less porous (denser) than spin-cast films, porosity alone does not account for the order of magnitude difference in conductivity. One may conclude from this study that the interlinking between particles is enhanced in EPD processing.

TABLE 4
Percentage Porosity in Spin-Case and EPO Films

| Deposition | Mass | Height | Volume | Density | Porosity | Solid |
|---|---|---|---|---|---|---|
| Method | (mg) | (nm) | (cm³) | (g/cm³) | % | Fraction |
| Spin | 0.08 | 149 | 3.35 × 10⁻⁵ | 2.39 | 57 | 0.43 |
| EPD | 0.12 | 154 | 3.47 × 10⁻⁵ | 3.46 | 38 | 0.62 |

Analysis of the carrier transport mechanism from the temperature-dependence conductivities of the films reveals a hopping conduction mechanism for charge transport (FIG. 5b). The trend shows a decrease in conductivity (ln σ) with decreasing temperature, which is typical for semiconductors where thermally activated hopping—the process in which a charge carrier in a localized state moves to another state via energy it receives from a phonon—is prominent. The hopping process extends beyond nearest neighbors with the further-distance hops resulting in smaller energy barriers. This process is counterbalanced by a decreasing tunneling probability over large distances, such that the conductivity is of the form

$$σ = {σ}_{0} exp ( - \frac{A}{{T}^{n}} ) ,$$

where A is a constant proportional to the activation energy and hopping probability. The power law (n) dependence of the temperature in the conductivity equation is reported as 1 or ½ for nearest-neighbor hopping (also thermally-activated hopping) or Efros-Shklovskii variable-range hopping (VRH), respectively. However, embodied data are best fit with a power of ¼, suggesting Mott variable-range-hopping mechanism (see Table 5). The linear dependence of ln σversus T^{-1/4} from 25 to ˜270 K in the spin-cast films and the EPD films in FIG. 5b is therefore indicative of variable-range hopping conduction in both films. While previous work showed a transition temperature at which conduction changes from VRH to nearest-neighbor hopping, embodied results do not exhibit any such transition in hopping mechanism, which is a similar conclusion found for a T^{-2/3} conductivity dependence in ZnO nanoparticles. The parameters A and σ₀ in the conductivity equation are extracted for Mott-VRH and shown in Table 6. The pre-exponential factor σ₀, which is about an order of magnitude higher in the EPD films than in the spin-cast films, is inversely proportional to the lattice spacing, further suggesting that better interparticle coupling is responsible for the enhanced conductivity in EPD films. Between 270 and 300 K, one observes that the conductivity in the EPD-1 film begins to deviate subtly from the expected hopping behavior, and, in fact, conductivity begins to decrease with increasing temperature. While the source of the deviation is not fully clear, such a trend of decreasing conductivity with increasing temperature has been observed in other studies on nanoparticle films where metal-like transport is suggested based on field-effect mobility measurements.

TABLE 5
Adjust —R² values of linear fits of conductivity with different powers
of temperature (T)

| Sample | 1/T | 1/T^{0.5} | 1/T^{0.25} |
|---|---|---|---|
| EPD1 | 0.962 | 0.970 | 0.950 |
| EPD2 | 0.852 | 0.951 | 0.982 |
| Spin-on-Si | 0.928 | 0.989 | 0.999 |
| Spin-on-glass 1 | 0.936 | 0.993 | 0.999 |
| Spin-on-glass 2 | 0.949 | 0.996 | 0.996 |

TABLE 6
Linear Fits of Conductivity to Mott Variable-Range Hopping Equation

| | A (K^{1/4}) | σ₀ (S · cm⁻¹) |
|---|---|---|
| EPD 1 | 4.04 | 134.04 |
| EPD 2 | 1.74 | 110.04 |
| Spin (glass) 1 | 5.51 | 21.45 |
| Spin (glass) 2 | 7.57 | 33.94 |
| Spin (Si) | 5.32 | 16.19 |

The temperature stability of the films is studied by extending the temperature range to 400 K (the maximum temperature of the PPMS). FIG. 19 shows the resistivity data for two films made by EPD and spin-casting. The temperature was cycled from 300 to 25 K, and then from 25 K to 400 K. For both film types, cycling from 25 to 300 K results in an increase in resistivity with a decrease in temperature; however, when cycling from 25 K to 400 K, a sharp and irreversible drop in resistivity (increased conductivity) is observed in the EPD and spin-cast film at 350 K and 380 K, respectively. The drop in resistivity suggests that the films are likely sintering at these higher temperatures. It is interesting to note that the EPD films sinter at lower temperatures than the spin-cast films. This is possibly due to the tighter packing of the EPD films over the spin-cast films. In addition, one may note that a recent study demonstrated irreversible thermal doping in Cu₂₋ₓS nanoparticle films above 350 K and this may provide an alternative explanation.

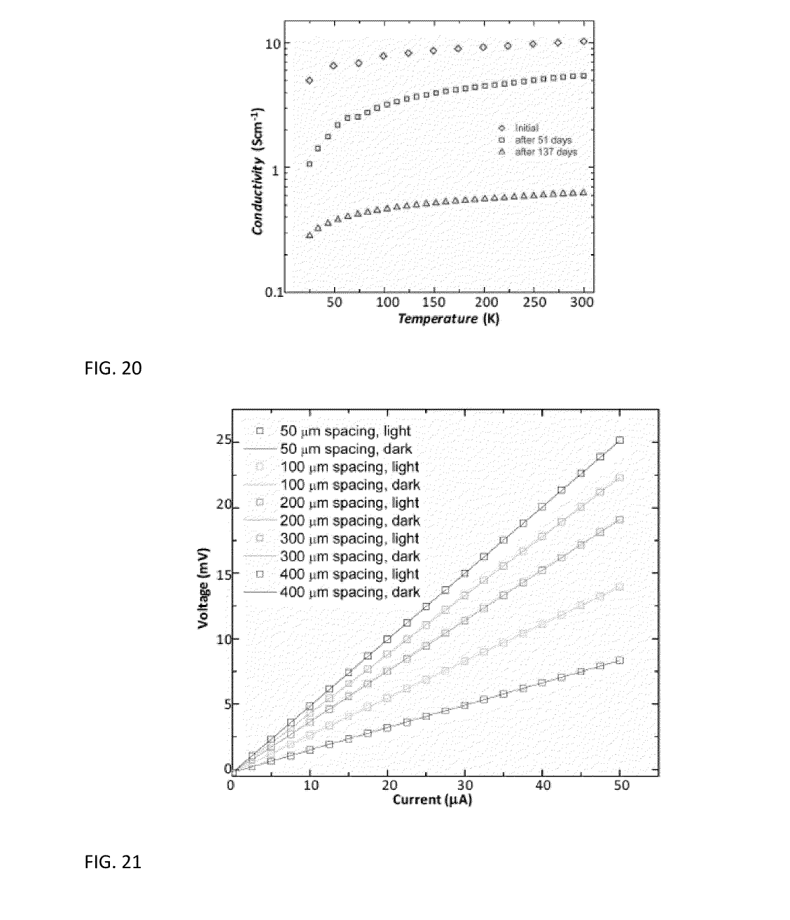

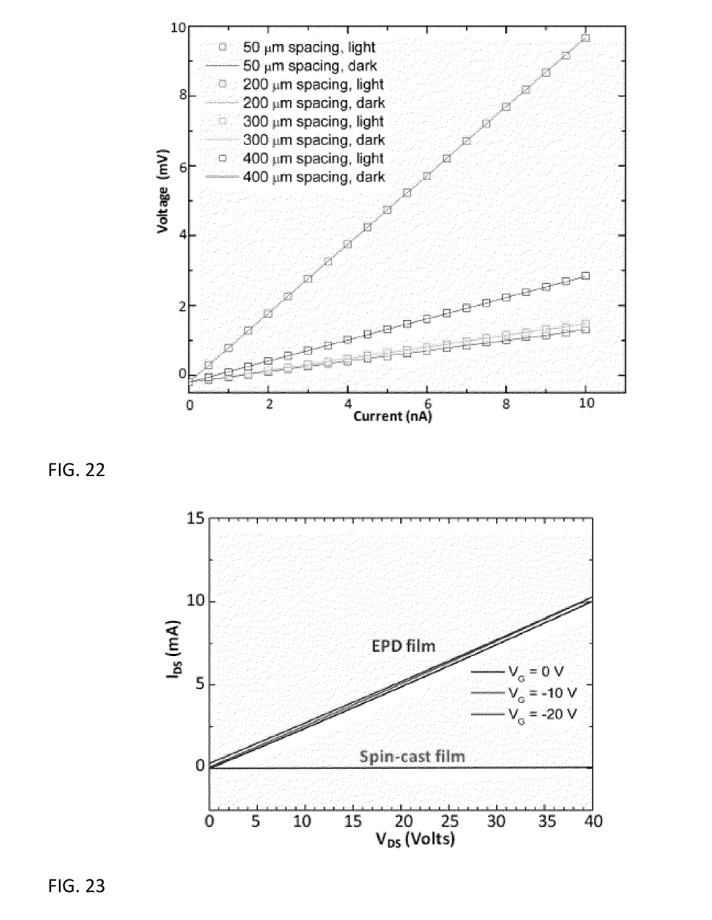

Also assessed was the light-sensitivity of the performance by measuring EPD and spin-cast films under 150 W illumination (Micro-Lite FL2000 High Intensity Fiber Optic Illuminator). For this study the electrode spacing was varied and the films were measured with four-wire resistance. Negligible light sensitivity was found in all cases. (See FIG. 20 for discussions on aging of the films in ambient conditions and FIG. 21 to FIG. 22 for data on light stability.)

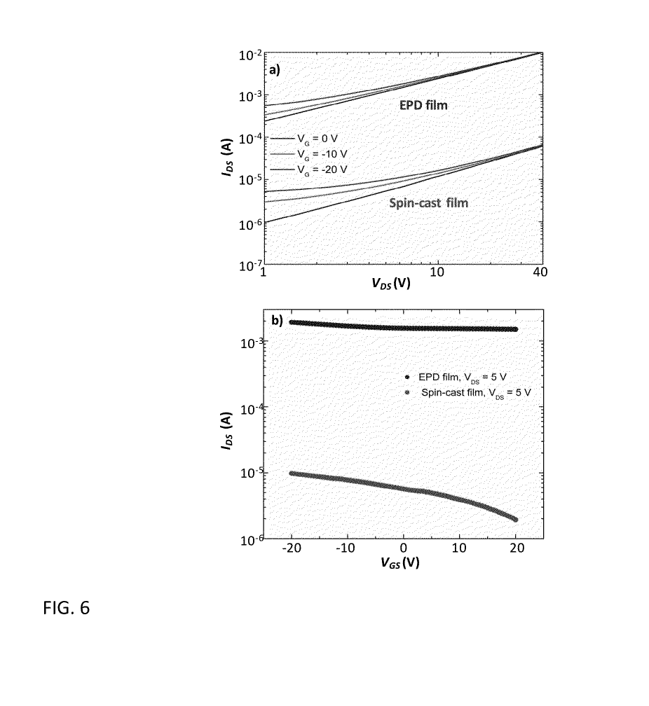

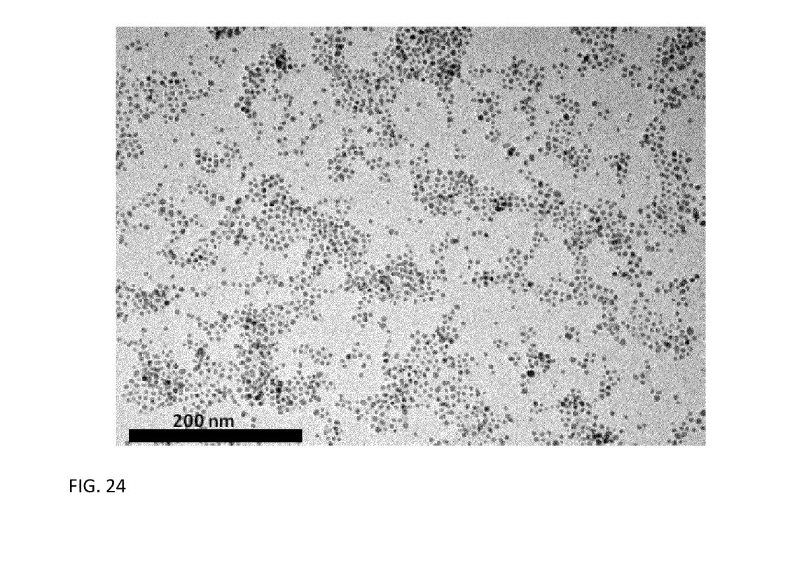

FIG. 6a and FIG. 6b, show the output and transfer characteristics of FET devices. The transistor geometry is bottom-gate bottom-contact, with the nanoparticles being deposited onto the source and drain electrodes via EPD and spin-casting (schematic of construction shown in FIG. 1a). The film thicknesses of the EPD and spin-cast films are ˜350 nm and ˜70 nm thick, respectively. The resulting transistor channel is 2.5 μm wide and 1 mm long. At gate voltage V_{GS}=0 V, a substantial drain-to-source current I_{DS} of ˜0.96 mA is measured at a drain-to-source voltage V_{DS}=4 V for EPD films, whereas at the same V_{DS} and V_{GS}, the drain current in the spin-cast films is 4.2 μA. Since conduction in FETs occur mostly via the surface channel, the difference in thickness cannot account for two orders of magnitude difference in current levels; hence, the higher current levels obtained from the EPD films further suggests that EPD films consistently form more conducting films than spin-cast films. The I_{DS}-V_{DS} graph is shown in logarithm-scale in order to display the differences between the EPD and spin-cast data on a single plot. Due to the two order of magnitude difference in I_{DS} between the EPD and spin-cast films, the features of the spin-cast data are suppressed when plotted on a traditional linear-scale (see FIG. 23). I_{DS} is slightly increased by changing the gate voltage from zero to negative values (−10 V and −20 V) for both EPD and spin-cast films, which is expected for a p-type semiconducting material, although the gate modulation is weak and no saturation occurs. Since the Cu₂₋ₓS films obtained from EPD and spin-casting are conducting, utilizing them in a FET-geometry as channel material would imply a depletion-mode operation for such transistor. Transfer characteristics (I_{DS}-V_{GS} plots at V_{DS}=5 V) of FETs made from both EPD and spin-cast films shown in FIG. 6b, depict no rectification; however, qualitative assessment of the plots indicate that the gate modulation is minimal and that the drain-source current level decreases by using positive gate voltages. The change in slope observed in the I_{DS}-V_{GS} plot of the EPD film near V_{GS}=0 V, which is not seen for the spin-cast films, is likely due to carrier depletion in the channel with positive gate voltages; however, the influence of charge trapping sites, which may be different for each film type might result in the disparity. Further studies on charge trapping mechanisms might provide better clarifications. From the I_{DS}-V_{GS} plot, one may calculate field-effect mobilities of 1.12 cm²V⁻¹ s⁻¹ and 0.0087 cm²V⁻¹ s⁻¹ for the EPD and spin-cast films respectively. One may note that the field-effect mobility of the spin-cast sample is lower than that obtained from Hall effect mobilities in Table 1. Although, FET measurements have been typically used to characterize the electronic properties of nanoparticle films, the results are strongly affected by charge trapping.

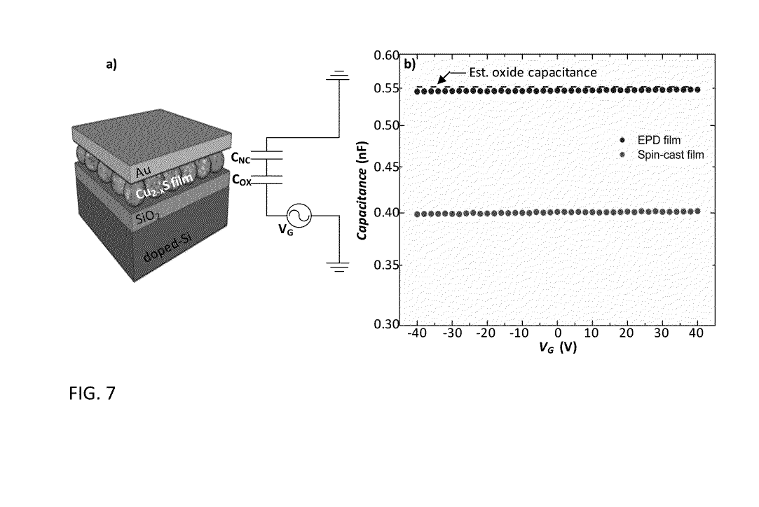

Capacitance-Voltage (C-V) measurements of EPD and spin-cast films reveal that the films are highly doped as their capacitance shows no voltage dependence. Fabricated were metal (Au)-semiconductor (copper sulfide)-insulator (silicon oxide)-metal (doped-Si) (MSIM) capacitors (FIG. 7a) and measured the equivalent capacitance C_{EQ} sweeping gate voltage from −45 to 45 V at 100 KHz with a precision LCR meter (Agilent 4284) as shown in FIG. 7b. The equivalent capacitance of the MSIM structures—a series arrangement of oxide capacitance C_{OX} and nanoparticle film capacitance C_{NP}—is shown in FIG. 7a. The measured equivalent capacitance C_{EQ}=(1/C_{OX}+1/C_{NP})⁻¹, with increasing film capacitance, C_{EQ} tends towards C_{OX}. The estimated oxide capacitance C_{OX} is ˜0.552 nF as depicted in FIG. 7b (assuming a dielectric constant of 3.9 for silicon oxide, area of 4.88 mm², and an oxide thickness of 300 nm.) Varying the gate voltage has negligible effect on the equivalent capacitance measured for both EPD (0.545 nF) and spin-cast films (0.4 nF), which further supports the minimal gate modulation seen in the output characteristics in FIG. 6a. These results, however, further support an assertion that more mobile charges are accumulated in EPD films than in spin-cast films; hence, the EPD films will have higher drain-to-source currents, as found in the FET measurements above. The constant capacitance with gate voltage, confirm that the Cu₂₋ₓS films obtained from both EPD and spin-cast are highly doped. Although it is difficult to quantify the carrier concentration from C-V plots, the Hall effect measurements shown in FIG. 4 helps to assess the highly-doped nature of the films.

### V. Conclusion

While the high conductivity observed in these Cu₂₋ₓS films does not make them ideal candidates for FET channel materials, they could potentially be utilized as source and drain electrode materials in an all-nanoparticle based transistor, as was recently demonstrated with Ag nanoparticles for the source and drain electrodes. In addition, Cu₂₋ₓS films could be employed as highly conducting p-type transparent conducting electrodes. The order of magnitude enhancement in conductivity obtained for our EPD films could be applied to enhance the conductivities of films shown to have high electron mobilities (>10 cm2/Vs) only after heat treatment or chemical doping.

In summary, it is shown that ammonium sulfide treatment of insulating Cu₂₋ₓS nanoparticle-based films results in highly conducting films comparable to physically deposited thin films. Further, it is show that EPD results in an order of magnitude enhancement in conductivity of these Cu₂₋ₓS films than spin-casting. The increase in conductivity is attributed to better interparticle coupling in the EPD films. The result of this study presents a scalable route to producing highly electrically conductive solution-processed films for electronic and optoelectronic applications.

### VI. Supplemental Information

### A. Further Details on Experimental Methods

### 1. Chemicals

Hexanes (≧98.5%), ethanol (≧99.5%), ammonium sulfide (40-48 wt % solution in water), oleylamine (70%), copper (I) chloride (99.995%) were purchased from Aldrich. Molecular sieves (UOP type 3 Å) were also purchased from Aldrich and activated at 300 C under dynamic vacuum for 3 hours before use.

### 2. Synthesis

A large-scale synthesis of Cu₂₋ₓS nanoparticles followed standard procedures. The synthesis was carried out in a dry, oxygen-free, dinitrogen atmosphere by employing standard Schlenk line and glove box techniques. A mixture of 1 g copper (I) chloride and 10 mL oleylamine was heated at 80° C. until the solution became clear. Temperature was then lowered to 50° C. and 10 mL molecular sieve-dried (NH₄)₂S oleylamine solution (0.5 mmol/mL) was added. The reaction was kept for 5 mins and the reaction flask was then immersed into an oil bath which has been pre-heated to 180° C. The reaction was allowed to proceed for 40 mins and cooled down by removing oil bath. Ethanol was added to the solution to precipitate out nanoparticles, which were separated by centrifugation and washed one more time with hexanes/ethanol. The purified NCs were dissolved in hexanes. The prepared nanoparticles were stored in ambient conditions prior to utilization for transport studies. Although the particles have likely aged, all comparisons of EPD and spin-casting are for films made from the same stock of re-dispersed nanoparticles.

### 3. Transmission Electron Microscopy

TEM images of the nanoparticle samples were obtained using a FEI Tecnai F12 microscope operating at 120 keV. At least 100 particles were analyzed per sample to obtain a representative size distribution.

### 4. X-Ray Diffraction

XRD (X-ray diffraction) spectra were collected using a Bruker General Area Detector Diffraction System (GADDS). Average grain sizes within the nanoparticle samples were determined from the XRD spectra using the Scherrer equation. The correction for instrumental broadening was conducted using the standard Al₂O₃ sample.

### 5. Atomic Force Microscopy

AFM imaging was conducted with an Asylum MFP-3D. Imaging was done in tapping mode with an Olympus AC1160TS probe and at a scan rate of 1 Hz.

### 6. Device Fabrication

Silicon-based devices were fabricated from p-doped silicon wafers (resistivity <0.005 W-cm, with ˜300 nm thick thermal oxide) purchased from Addison Engineering Inc. Metal layers for all devices (with the exception of the MSIM capacitors) were deposited using lift-off techniques. For the MSIM capacitors, a shadow mask was utilized to deposit the gold films onto the nanoparticles. Electron-beam evaporation was used throughout for metal deposition.

### 7. FET Measurements

All FET measurements were taken with a Karl Suss PM6 probe station equipped with Keithley 237 source measurement units.

### 8. Capacitance-Voltage Measurements

C-V data were taken with an Agilent 4284 Precision LCR meter equipped with an Agilent 16047A Text Fixture. The Hpot and Hcur leads are connected to the gate (doped-Si), and the Lpot and Lcur leads are connected to the reference (Au).

### 9. X-Ray Photoelectron Spectroscopy (XPS)

XPS data were collected on a Surface Science Instruments SSX-100 operating a pressure <2×10-9 Torr and with monochromatic Al Kα X-rays at 1486.6 eV.

### B. Supplementary Information on Characterization of Nanoparticles and Nanoparticle Films

Scanning electron micrographs and AFM images of films prepared by EPD and spin-casting suggests that EPD films are more compacted. FIG. 8a-d shows scanning electron micrographs (SEM) of typical Cu₂₋ₓS films deposited by EPD and spin-casting, treated with ammonium sulfide, that was measured in our studies. The SEM images were processed with ImageJ software (National Institute of Health) in order to assess the packing of the film. By first applying high contrast to the SEM images and thresholding the resulting image, the pores and particles in the image are counted and sized. Upon analyzing images of the EPD and spin cast films in FIGS. 8b and d, the percentage area of the nanoparticles is found to be 63% and 40%, respectively, suggesting that the EPD films are more compacted than spin-cast films for all the films observed in the SEM. This basic particle count analysis, which focuses mostly on the topmost layer of the films, could be improved by carrying more rigorous pore sorption measurements in the future. Tapping mode height and phase AFM images of EPD and spin cast films are taken to further understand the film compaction as shown in FIG. 1e-h. The root mean square (rms) roughness of the 1 μm×1 μm scan area of the EPD and spin-cast film is 6 nm and 14 nm, respectively. (One may note that the AFM images were taken using a tip of radius of ˜8 nm; hence, the images do not laterally resolve individual particles ˜5 nm in diameter.) The phase images (FIGS. 8g and h), which monitor the phase lag between the drive signal of the cantilever and the actual cantilever oscillation, reveal the homogeneity of the deposited films of the films as tip interaction with different materials result in different phase offsets. In addition, the phase images show that the porous region of the films have a larger phase offset than regions with nanoparticles, providing better visualization of the packing of the films. These results suggest that EPD forms more closely packed nanoparticle films than spin-cast films and are thus likely to have better interparticle coupling, corroborating the observation from the SEM images.

C. Supplementary Discussion: Percentage Area Estimation with ImageJ

From the SEM images of the nanoparticle films in FIG. 8, one may observe that the EPD films appear to have smaller pore sizes then spin-cast films. However, in order to obtain a more quantitative estimate of the percentage area of the images that consist of nanoparticles, the SEM images were processed with ImageJ. One may note that since the films are made from multiple deposition cycles, this analysis method is mostly providing information about the topmost layer of the films. First one enhances the contrast of the images by 100% to better distinguish the nanoparticle regions and the pores—leading to a binary image with higher pixel intensity for the nanoparticle regions, and low intensity for the pore regions, since the original SEM images are grayscale. With ImageJ, one may assure that a threshold value of 129 is obtained for the enhanced contrast images, which implies converting the original grayscale images into binary images with only two pixel values, 0 and 255, corresponding to pore regions and nanoparticle regions respectively. The percentage of pixels with 255 value then represent the area occupied by the nanoparticles. The results are shown in FIG. 11.

### D. Supplementary Discussion: Film Performance Over Time

The conductivity of one of the spin-cast films measured in ambient over time suggest a degradation in film performance with time as shown in FIG. 20: After 50 days, room temperature conductivity remains the same order of magnitude, but after 140 days, room temperature conductivity drops by and order of magnitude. Such studies will be important considerations needed for practical applications. Perhaps, the films should not be stored in ambient conditions for a lengthy study.

### E. Supplementary Discussion: Light Stability

In order to assess the sensitivity of the films to light, four-wire resistance measurements of the films deposited on two gold electrodes of varying spacing (50 to 400 μm) were performed in dark (in an enclosed probe station) and in light (with Microlite FL2000 150 W Fiber Optic Illuminator). One may observe negligible changes in film resistance in the films as shown in FIG. 21 and FIG. 22. In addition, the resistance of the EPD films increases with increasing electrode spacing suggesting a more uniform film, while the spin-cast films appear to have an inhomogeneous coverage.

All references, including publications, patent applications, and patents cited herein are hereby incorporated by reference in their entireties to the extent allowed, and as if each reference was individually and specifically indicated to be incorporated by reference and was set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein is merely intended to serve as a shorthand method of referring individually to each separate value falling within the range, unless otherwise indicated herein, and each separate value is incorporated into the specification as if it was individually recited herein.

All methods described herein may be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A composition comprising:
a substrate; and
a copper chalcogenide material layer located over the substrate and having a conductivity at least about 50 S·cm⁻¹.

2. The composition of claim 1 wherein the copper chalcogenide material layer comprises:
a layer of bare copper chalcogenide nanoparticles; and
a layer of chalcogenide material laminated to the layer of bare copper chalcogenide nanoparticles and bridging to individual nanoparticles within the layer of bare copper chalcogenide nanoparticles.

3. The composition of claim 1 wherein the substrate comprises at least one of a conductor substrate and a semiconductor substrate.

4. The composition of claim 1 wherein the copper chalcogenide material layer comprises at least one chalcogenide selected from the group consisting of selenium and tellurium.

5. The composition of claim 1 wherein the copper chalcogenide material layer has a copper:chalcogen atomic ratio is from about 1.0 to about 2.0.

6. The composition of claim 1 wherein the conductivity is at least about 60 S·cm⁻¹.

7. The composition of claim 1 wherein the conductivity is at least about 70 S·cm⁻¹.

8. The composition of claim 1 wherein the conductivity is at least about 80 S·cm⁻¹.

9. The composition of claim 1 wherein the conductivity is at least about 90 S·cm⁻¹.

10. The composition of claim 1 wherein the conductivity is at least about 100 S·cm⁻¹.

11. The composition of claim 1 wherein the copper chalcogenide material layer has a thickness from about 100 to about 150 nanometers.

12. A composition comprising:
a substrate; and
a copper sulfide material layer located over the substrate and having a conductivity at least about 75 S·cm⁻¹.

13. The composition of claim 12 wherein the substrate comprises at least one of a conductor substrate and a semiconductor substrate.3

14. The composition of claim 12 wherein the copper sulfide material layer has a copper:sulfur atomic ratio is from about 1.0 to about 2.0.

15. The composition of claim 12 wherein the copper sulfide material layer has a conductivity greater than about 50 S·cm⁻¹.

16. The composition of claim 12 wherein the copper sulfide material layer has a thickness from about 100 to about 150 nanometers.

17. A method comprising:
depositing while using an electrophoretic deposition method a metal nanoparticle material layer upon a substrate; and
treating the metal nanoparticle material layer with a chalcogenide source material to form from the metal nanoparticle material layer upon the substrate a metal chalcogenide material layer upon the substrate.

18. The method of claim 17 wherein the substrate comprises at least one of a conductor substrate and a semiconductor substrate.

19. The method of claim 17 wherein the metal nanoparticle material layer comprises a metal selected from the group consisting of zinc, manganese, cobalt, molybdenum, cadmium, lead and tin metals.

20. The method of claim 17 wherein the metal nanoparticle material layer comprises a copper metal.

21. The method of claim 17 wherein the chalcogenide source material is selected from the group consisting of selenium and tellurium chalcogenide source materials.

22. The method of claim 17 wherein the chalcogenide source material comprises a sulfur chalcogenide source material.

23. The method of claim 17 wherein the metal chalcogenide material layer has a thickness from about 100 to about 150 nanometers.

24. A method comprising:
forming upon a substrate while using an electrophoretic deposition method a surfactant templated copper nanoparticle material layer; and
treating the surfactant templated copper nanoparticle material layer with a sulfur material to form from the surfactant template copper nanoparticle material layer a copper sulfide material layer having a conductivity at least about 75 S·cm⁻¹.

25. The method of claim 24 wherein:
the sulfur material comprises an ammonium sulfide material; and
the copper sulfide material layer has a thickness from about 100 to about 150 nanometers.
